(19) United States
(12) Patent Application Publication
(10) Pub. No.: US 2014/0096045 A1
(43) Pub. Date: Apr. 3, 2014

(54) ALARM CLUSTERING MECHANISM

(71) Applicant: FLUKE CORPORATION, Everett, WA (US)

(72) Inventors: Vera B. Dobryanskaya, Colorado Springs, CO (US); Bryan Kent Laver, Colorado Springs, CO (US); Bruce James Kosbad, Colorado Springs, CO (US)

(73) Assignee: Fluke Corporation, Everett, WA (US)

(21) Appl. No.: 13/630,028

(22) Filed: Sep. 28, 2012

(51) Int. Cl. G06F 3/0484

(52) U.S. Cl. CPC G06F 3/04842
USPC 715/765

(57) ABSTRACT

A method is disclosed. The method includes identifying locations of one or more points of interest, identifying an area of interest on a map displayed on a display device, identifying points of interest within the area of interest, selecting a level of detail and clustering the points of interest within the level of detail based on the location of the points of interest relative proximity to other points of interest.

### BACKGROUND

Wide area network (WAN) optimization increasingly is being used to improve the performance and efficiency of WANs that transport data among sites. Various types of WAN optimization (also known as WAN acceleration) are offered by vendors such as Cisco Systems, Riverbed Technology, Juniper Networks, Citrix Systems, and others. Typically, WAN optimization products include a suite of different types of WAN optimization which can generally be categorized as: traffic or flow management; caching; compression; protocol optimization; and error correction.

Service providers and enterprises have historically managed their networks by placing network management devices at key points in the network. These network management devices monitor network performance and communicate information to backend network operations centers for troubleshooting and corrective action. As WAN optimization becomes increasingly ubiquitous, it would be desirable to enhance the capability to monitor the impact of the various types of optimization on network performance, from a high level down to the individual transaction level.

### SUMMARY

In one embodiment, a method is disclosed. The method includes identifying locations of one or more points of interest, identifying an area of interest on a map displayed on a display device, identifying points of interest within the area of interest, selecting a level of detail and clustering the points of interest within the level of detail based on the location of the points of interest relative proximity to other points of interest.

### BRIEF DESCRIPTION OF THE DRAWINGS

A better understanding of the present invention can be obtained from the following detailed description in conjunction with the following drawings, in which:

FIG. 1 is a block diagram of a network environment in which the network monitoring and analysis techniques described herein may be employed;

FIG. 2 is a flow diagram illustrating one embodiment for clustering alarms;

FIGS. 3A-3C are screen shots illustrating embodiments of clustering on a site map; and

FIG. 4 illustrates one embodiment of a computer system.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

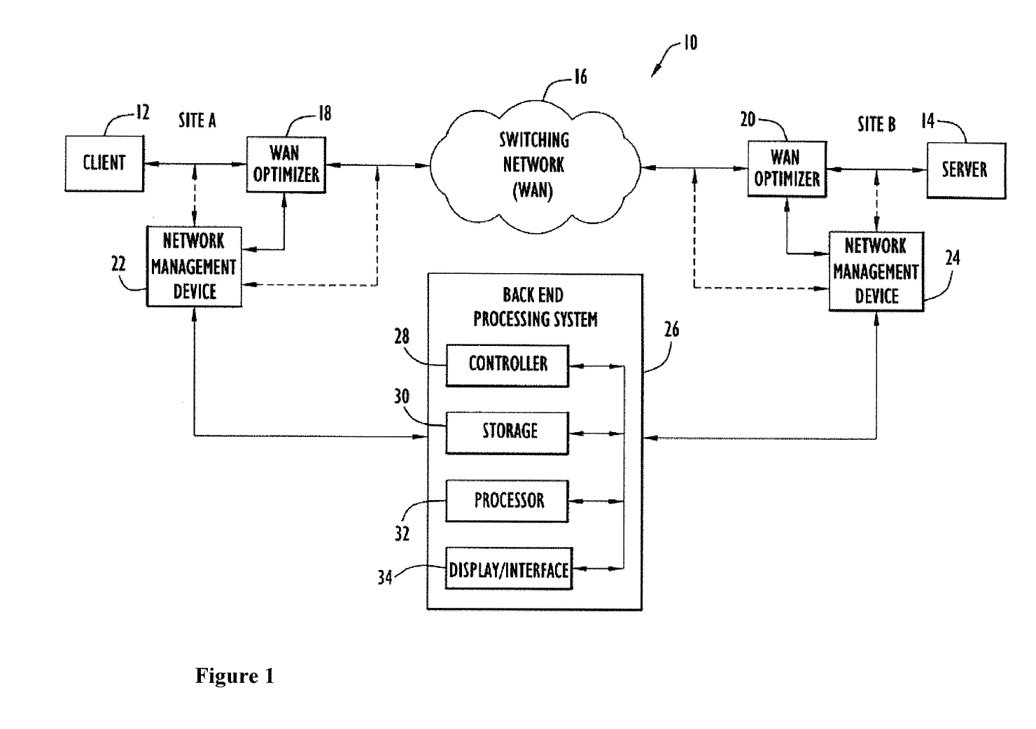

FIG. 1 illustrates, at a very general level, a data transmission system (communication network) that includes a network management system for monitoring performance of the network. As shown in FIG. 1, an exemplary data transmission system 10 includes a number of sites, including sites A and B, and a switching network 16 such as a wide area network (WAN) to facilitate communications between the sites. Each of sites A and B may include, for example, one or more local area networks (LANs). Routers (not shown in FIG. 1) may interconnect the local site LANs ultimately to the WAN represented by the switching network cloud 16 in FIG. 1.

A packet traveling across the WAN between the devices at the endpoint sites traverses one or more network paths connecting the sites. Typically, a packet's path includes several physical communication links and intermediate devices (e.g., switches and/or routers) that transmit a packet along a correct route from one site to another, and transmit the response packets back across the network in the opposite direction.

Site A may include a client 12 that communicates with a server 14 at site B over network 16. The terms “client” and “server” are reference labels used here for convenience and descriptiveness due to their common usage in the art and to avoid confusion as to which end point is being referred to in the following descriptions of exchanges between devices at two locations. However, it will be appreciated that the invention is not limited to any particular devices or equipment, and the invention is applicable in the context of any computing devices or network equipment communicating or exchanging information over a network. Generically, both devices involved in an exchange over a network also can be considered “host” devices or simply “user” devices.

WAN optimization unit (WAN optimizer) 18 is provided at site A between the client 12 and WAN 16 and is capable of performing one or more of the previously-described WAN optimization techniques. One non-limiting example of such a WAN optimizer is Cisco Systems' Wide Area Application Engine (WAE) device which provides aforementioned WAAS optimization options.

In general, the WAN optimizer may provide a suite of optimization techniques, such as those previously described, and can be configured to suit the needs of the network devices supported at the site. A similar WAN optimizer 20 can be provided at site B between server 14 and WAN 16. The WAN optimizers 18 and 20 on each end intercept TCP connections (for example) across the network and optimize the TCP connections. While both sites shown in FIG. 1 include a WAN optimizer, it is possible that other sites or devices communicating over network 16 may lack a WAN optimizer, and client 12 and/or server 14 may communicate with devices at such other sites.

In the general example shown in FIG. 1, the data transmission system 10 may include any of a number of communications line types and a variety of data communications connections. Sites A and B are each capable of transmitting and receiving data packets in various protocols utilized by the communication lines. As used herein the terms “data network,” “switching network,” “network,” “LAN,” “WAN,” etc. refer to networks that carry virtually any kind of information and are not limited to any particular type of hardware, technology, protocol, application, or data (audio, video, digital data, telephony, etc.). For illustrative purposes, only two sites (A and B) are shown in FIG. 1. However, it will be understood that the data communication system can include numerous sites, wherein each site is generally connected to multiple other sites over corresponding transmission circuits within the switching network.

The network management system includes a number of network management devices (NMDs) 22, 24 located throughout the network, which monitor network activity and collect network performance data, and at least one back-end processing system 26 that coordinates and controls the system, collects and processes measurement data received from the NMDs, monitors and analyzes network performance, displays network performance, and notifies network operators when performance problems are detected. Such a network management system can provide, for example: accurate and reliable measurement of performance metrics such as network latency, jitter, data delivery ratio, and throughput; management of user performance requirements with configurable sensitivity; a context-sensitive data repository which enables the assessment and evaluation of network performance with respect to circuit, time, bandwidth, and performance requirements; and/or forecasting of potential or developing network performance problems.

As shown in FIG. 1, network management devices (NMDs) 22 and 26 are respectively disposed at sites A and B or at some point between WAN 16 and sites A and B, respectively. In general, NMDs can be placed at virtually any point in the network or any point within an enterprise LAN (e.g., at local sites, at intermediate points between local sites and the WAN, and within the WAN itself).

The placement of the NMDs depends at least in part on the portion of the system or network over which a network service provider or other party wishes to monitor performance of data traffic flow. For example, NMDs can be connected to a local router or switch such that the NMD is not in-line with the data flow path through the router between the LAN(s) and the WAN. NMDs can also be connected in-line between a local router and a customer edge router (CER), or in-line between a CER and the WAN, for example.

The NMDs may be any type of monitoring device or probe and can comprise standalone hardware/software devices or software and/or hardware added to network equipment such as PCs, routers, CSU/DSUs (channel service unit/data service unit), FRADS, voice switches, phones, etc. Software embedded in the NMDs can collect network performance data for detailed analysis and report generation relating to any of a variety of performance metrics.

By way of a non-limiting example, an NMD can be a CSU/DSU that operates both as standard CSU/DSU and as a managed device capable of monitoring and inserting network management traffic; an inline device residing between a DSU and router, which monitors network traffic and inserts network management traffic; or a passive monitoring device that only monitors network traffic. The NMDs can also be “active” monitoring devices capable of inserting test packets or messages into the data traffic.

In the example shown in FIG. 1, NMDs are respectively located at both the client site A and at the server site B; however, it is also possible to have an NMD at only one of the two sites involved in a client-server exchange. In the arrangement shown in FIG. 1, NMD 22 at client site A is not in-line with the traffic flow between client 12, WAN optimizer 18, and WAN 16; however, NMD 22 could be arranged in-line with client 12 and WAN optimizer 18.

NMD 22 can passively monitor traffic from the signal line between client 12 and WAN 16 and receives WAN optimization policy information from WAN optimizer 18. Alternatively, NMD 22 may actively communicate with WAN optimizer 18 and/or have an active roll in traffic flow. The same configuration options exist for NMD 24 at the server site B.

Each NMD may collect measurement data relating to any of a variety of performance metrics associated with operation of the network including, but not limited to latency, response times, network round-trip time, jitter, data delivery ratio, throughput, and other measures indicative of delivery efficiency and failure rates. It will be understood that the invention is not limited to the measurement or analysis of any particular performance metric or any particular combination of metrics.

The backend processing system 26 of the network management system shown in FIG. 1 receives measurement data either directly or indirectly from the NMDs, and collects and stores measurement data and processes the data to produce the various displays and reports required to monitor performance of the network and its components.

The architecture depicted in FIG. 1 is a conceptual diagram illustrating major functional units and does not necessarily illustrate physical relationships or specific physical devices within the backend processing system or between the backend processing system and the NMDs. The configuration and components of the backend processing system can take many forms and are described herein only in general terms for context. Those skilled in the art will appreciate that the techniques described herein for communicating within a network management are applicable regardless of the particular architecture of the backend processing system or NMDs.

Backend processing system 26 includes a controller module 28 responsible for coordinating and controlling the network management system. For example, controller 28 may be responsible for sending instructions to the various NMDs and periodically polling the NMDs to collect measured data. A data storage capability of the backend processing system is represented by storage module 30 for storing measurement data as well as information generated by processing measurement data, such as aggregated report data, analysis results, and historical information.

Processing system 26 further includes a management and processing capability represented in FIG. 1 by processor module 32, which performs various processing tasks, such as performing operations on raw measurement data to produce reports and performing analysis operations. The backend processing system 26 further includes a display, interface, and report capability represented by display/interface module 34, which displays performance information in a tabular or graphical manner via an interactive graphical user interface (GUI), for example, and preferably includes the capability to generate various performance reports.

Display device 34 may be any of a wide variety of known devices, such as an LCD display whose optical state is transformed by controlling the color of light emitted by individual pixels based on input from a user (mouse, keypad, touch screen, etc.) or from a processor. For example, the display device 34 may be a GUI which allows the user to selectively control the format and content of the display.

The backend processing system 26 may receive measurement data directly from the NMDs or may receive measurement data indirectly (e.g., the NMDs may supply measurement data to a storage device at the local site, which is subsequently supplied to the backend processing system 26. Further, the backend processing system 26 may be located at a single site or may have components distributed throughout the network at multiple locations

For example, storage module 30 may constitute storage capabilities at a number of local sites as well as a storage capability at one or more backend processing sites. Likewise, various backend processing tasks, nominally represented by processor 32 in FIG. 1, may be performed by a number of different processors that carry out specific tasks and that may be distributed throughout the network. Similarly, the display/interface capability may allow access to performance information via interfaces at a number of sites or via a web-based interface accessible to authorized customers or service provider personnel.

In one embodiment, a GUI displayed at display device 34 includes a map control feature that enables alarms to be placed on a map in order to provide a visual indication at a geographical location on the map corresponding to an area at which the network is reporting problems. A problem may occur, however, when there are too many concurrent alarms located within a small geographical distance on the map. In such instances the alarm display may become crowded and confusing, making it difficult to assess the overall situation, correlate related problems and determine appropriate actions.

According to one embodiment, backend processing system 26 clusters alarms based on arbitrary geographically defined regions. Thus, backend processing system 26 stores and manages definitions of the defined geographical regions. In a further embodiment, alarm clusters correspond to responsibilities and organizations of specific enterprises, departments and groups.

In such an embodiment, multiple hierarchical organizations levels (e.g., country, state/province, and county) are represented on the map. In a further embodiment, adjacent and disjoint regions (e.g., the Alaska and Hawaii, which are not in close proximity to the lower 48 states in the United States) may be represented. Additionally, the regional definitions may be dynamically changed, extended or replaced, which enables flexibility to respond to requirements of many organizations.

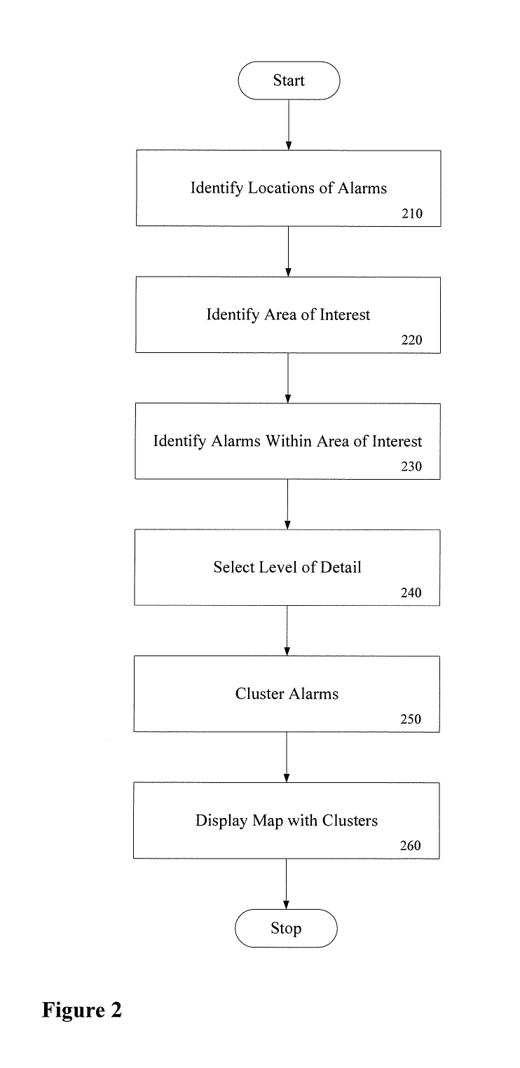

FIG. 2 is a flow diagram illustrating one embodiment for clustering alarms. At processing block 210, initial geographic locations of a collection of alarms (e.g., city, site or address) is identified. In one embodiment, a geographic location is identified upon a user of the GUI selecting an area of the map. At processing block 220, an area of interest is identified. According to one embodiment, an area of interest may include the world, a continent, country, region, etc.).

At processing block 230, alarms within the area of interest are identified. In one embodiment, a distance formula is implemented to determine the distance of the alarm from the area of interest. In such an embodiment, the alarm is deemed within the area of interest if within a predetermined distance the area of interest.

At processing block 240, an appropriate level of detail within the regional hierarchy is selected. According to one embodiment, the level of detail is selected via a zoom operation being performed on the map in order to properly display the area of interest. At processing block 250, the alarms are clustered within the level of regional detail based on both the location of the alarms within a region and their relative proximity to each other. At processing block 260, the map with clustered alarms is displayed.

Such a clustering process enables clustering of alarms within the lower 48 states of the United States, while enabling separate clustering of alarms for each of Alaska and Hawaii. In a further embodiment, the clustering process occurs dynamically to change clustering as focus on the map changes (e.g., widens or narrows) in order to make best use of an area of interest selected via the GUI.

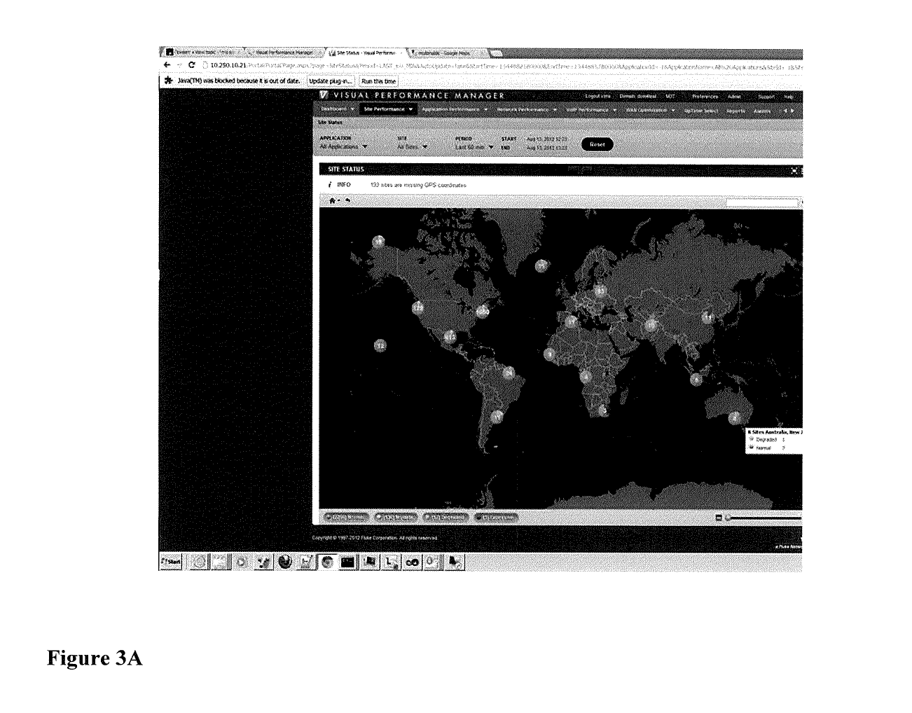

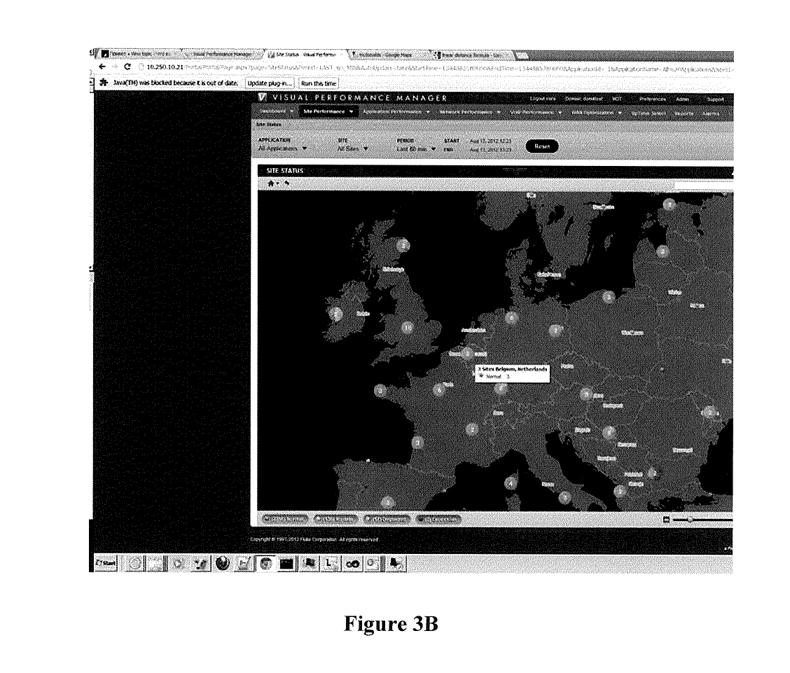

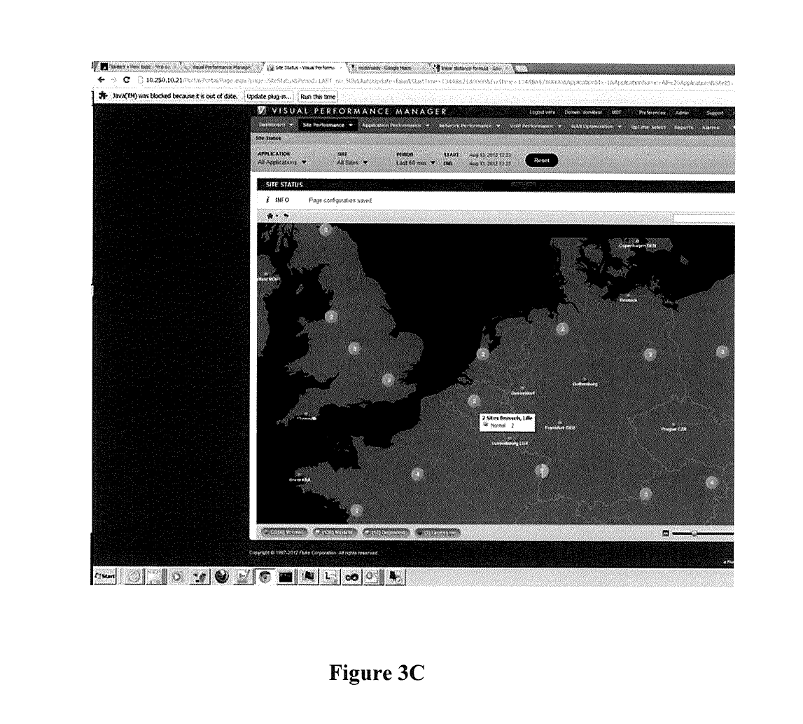

FIGS. 3A-3C are GUI screen shots illustrating embodiments of clustering on a displayed site map. FIG. 3A shows a clustered alarm dataset that includes the countries of the world as the area of interest. FIG. 3B shows a clustered alarm dataset dynamically changed for a higher zoom level, with the countries in Europe being the area of interest. FIG. 3A shows a clustered alarm dataset for a “City” zoom level, with Belgium and France being the area of interest.

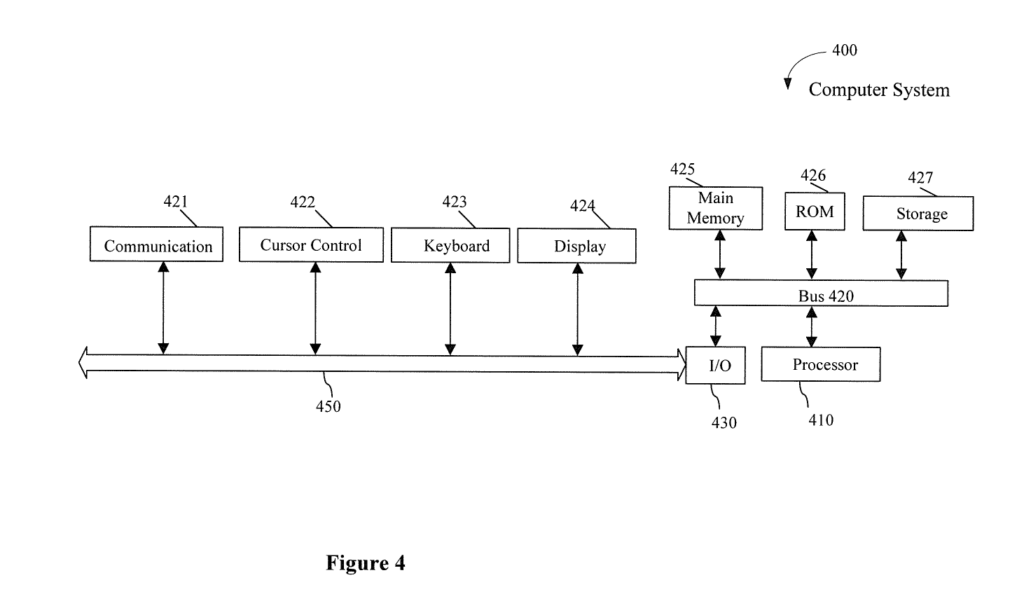

FIG. 4 illustrates a computer system 400 on which client 12, server 14 and/or processing system 26 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer-generated method comprising:
identifying locations of one or more points of interest
identifying an area of interest on a map displayed on a display device;
identifying points of interest within the area of interest;
selecting a level of detail; and
clustering the points of interest within the level of detail based on the location of the points of interest relative proximity to other points of interest.

2. The method of claim 1 further comprising displaying the clustered points of interest on a map.

3. The method of claim 1 wherein the area of interest includes one of the world, a continent, a country or a region.

4. The method of claim 1 wherein the distance of the point of interest from the area of interest is determined using a distance formula.

5. The method of claim 4 wherein point of interest is deemed within the area of interest if within a predetermined distance the area of interest.

6. The method of claim 1 wherein the locations are identified upon receiving a user selection via a graphical user interface (GUI).
